(19) United States
(12) Patent Application Publication
(10) Pub. No.: US 2025/0151167 A1
(43) Pub. Date: May 8, 2025

(54) Network Traffic-Based Incident Detection

(71) Applicant: Avila Visualization Inc., Palm Beach Gardens, FL (US)

(72) Inventor: Don Reich, Westlake Village, CA (US)

(21) Appl. No.: 18/741,381

(22) Filed: Jun. 12, 2024

Related U.S. Application Data
(60) Provisional application No. 63/595,874, filed on Nov. 3, 2023.

(51) Int. Cl. H04W 76/50; H04M 3/51; H04W 64/00

(52) U.S. Cl. CPC H04W 76/50; H04M 3/5116; H04W 64/003

(57) ABSTRACT

A computing system comprises one or more processors and one or more storage devices that comprise instruction code. The instruction code is executable by the processors to cause the computing system to receive, from an emergency call routing system, emergency location information associated with emergency calls placed by a plurality of user communication devices. The emergency location information specifies geographic location information associated with the locations of the user communication devices. The computing system implements machine learning (ML) logic trained to infer based on the emergency location information whether an incident has occurred at one or more particular geographic regions and communicates the emergency location information as input to the ML logic. After the ML logic indicates that an incident has occurred at the one or more particular geographic regions, communicate an indication of the incident to one or more third parties.

### RELATED APPLICATIONS

This application claims the benefit of priority under 35 U.S.C. § 119 (c) of U.S. Provisional Application No. 63/595,874, filed Nov. 3, 2023, the content of which is incorporated herein by reference in its entirety.

### SUMMARY

In a first aspect, a computing system comprises one or more processors, and one or more storage devices that comprise instruction code that is executable by the one or more processors. The instruction code is executable by the processors to cause the computing system to receive, from an emergency call routing system, emergency location information associated with emergency calls placed by a plurality of user communication devices. The emergency location information specifies geographic location information associated with locations of the user communication devices. The computing system implements machine learning (ML) logic trained to infer based on the emergency location information whether an incident has occurred at one or more particular geographic regions. The computing system communicates the emergency location information as input to the ML logic. After the ML logic indicates that an incident has occurred at the one or more particular geographic regions, the computing system communicates an indication of the incident to one or more third parties.

In a first aspect, a computing system comprises one or more processors, and one or more storage devices that comprise instruction code that is executable by the one or more processors. The instruction code is executable by the processors to cause the computing system to receive, from an emergency call routing system, emergency location information associated with emergency calls placed by a plurality of user communication devices. The emergency location information specifies geographic location information associated with locations of the user communication devices. The computing system determines whether a frequency of the emergency calls made during a predetermined period and within one or more particular geographic regions exceeds a threshold frequency. When the frequency of the emergency calls exceeds the threshold frequency, the computing system communicates an indication of an incident to one or more third parties. When the frequency of the emergency calls does not exceed the threshold frequency, the computing system forgoes communication of the indication.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that facilitate the detection of an incident based on network traffic generated by various networked devices, in accordance with example embodiments.

FIG. 2 illustrates an incident detection system, in accordance with example embodiments.

FIG. 3A illustrates a geographic area in which emergency calls may have been made, in accordance with example embodiments.

FIG. 3B illustrates a geographic area in which emergency calls may have been made and in which a catastrophic incident has occurred, in accordance with example embodiments.

FIG. 4 illustrates operations that facilitate inferring the occurrence of a catastrophic incident at one or more particular geographic regions, in accordance with example embodiments.

FIG. 5A illustrates operations that facilitate training machine learning (ML) logic to infer the occurrence of a catastrophic incident at one or more particular geographic regions, in accordance with example embodiments.

FIG. 5B illustrates operations that facilitate determining a suitable perimeter for a target region, in accordance with example embodiments.

FIG. 6 illustrates operations that facilitate determining the occurrence of a catastrophic incident at one or more particular geographic regions, in accordance with example embodiments.

FIG. 7 illustrates a user interface that facilitates visualizing locations of emergency calls, in accordance with example embodiments.

FIG. 8 illustrates a computer system that can form part of or implement any of the systems and/or devices described above, in accordance with example embodiments.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

### I. Introduction

When a 911 emergency call is placed, an emergency call routing system, such as a 911 network/system, may determine the caller's location and selectively route the emergency call to an appropriate Public Safety Answering Point (PSAP) based on the determined location of the caller. The emergency call routing system may, in addition to routing the call, communicate the determined location to the PSAP. Trained call takers at the PSAP may then answer the call and gather essential details from the caller to assess the nature of the emergency and transfer the details to the nearest dispatch center responsible for that area. This carefully coordinated system ensures that 911 calls are efficiently routed to the appropriate PSAP, allowing for prompt and effective emergency assistance to be provided to those in need.

Determining the location of the caller generally depends on the type of device that was used to make the emergency call. For instance, when a landline device is used, an Automatic Number Identification (ANI) system of or in communication with the emergency call routing system may determine the phone number associated with the call. The emergency call routing system may then query an Automatic Location Identification (ALI) database, which relates phone numbers to street addresses, apartment numbers, etc., to determine the street address associated with the phone number.

The location of mobile devices is determined using so-called enhanced 911 services (E911). The basic/initial location service implementation (Phase 1) of E911 involves determining the location of the mobile device based on the coverage region of the cell tower with which the mobile device is communicating. For example, the caller of a mobile device in coverage region A is assumed to be located somewhere in region A. Clearly, if region A is large, pinpointing the location of the caller based just on the assumed location of the mobile device will be difficult. Phase 2 E911 services improve upon this. When a Phase 2 emergency call is placed, the mobile network identifies the mobile device location using techniques that involve triangulating the location of the mobile device using several cell towers. In some instances, the location may be determined (or refined further) based on information provided by Global Navigation Satellite System (GNSS) hardware of the mobile device. This location information may be communicated to the emergency call routing system, which may then responsively select and route the emergency call and the location information to an appropriate PSAP.

The number of emergency calls that can be simultaneously processed by a PSAP at any given instant is limited, for example, due to the limited number of operators available to answer the calls. This can be problematic when a large number of emergency calls are made within a region serviced by the PSAP within a short period of time. For example, during a mass causality event in a region represented by a particular PSAP, the PSAP may be inundated with emergency calls, and many of these calls may go unanswered. Further, while PSAPs dispatch indications of such events to first responders, they do not generally inform other stakeholders to whom the information may be beneficial. For example, it may be beneficial for school administrators to be made aware of an incident that occurs on a school campus so that they can take timely/necessary precautions to ensure campus safety.

Disclosed herein are example incident detection systems and methods performed by examples incident detection systems that facilitate notifying stakeholders of the occurrence of such events. An example system is configured to receive, from an emergency call routing system, emergency location information associated with emergency calls placed by a plurality of user communication devices. The emergency location information specifies geographic location information associated with the locations of the user communication devices. The system implements machine learning (ML) logic trained to infer based on the emergency location information whether an incident has occurred at one or more particular geographic locations and communicates the emergency location information as input to the ML logic. After the ML logic indicates that an incident has occurred at one or more particular geographic locations, the system communicates an indication of the incident to one or more third parties/stakeholders. In some examples, the system filters the emergency location information according to a particular geographic area, and communicates the filtered emergency location information as the input to the ML logic.

In some examples, the emergency location information is Internet Protocol (IP) based emergency location information that conforms to a NENA-STA-010.3d-2021 standard promulgated by the National Emergency Number Association (NENA) 911 Core Services Committee, i3 Architecture Working Group and the emergency call routing system routes the emergency location information to one or more PSAPs.

In some examples, the system searches a list for one or more stakeholders to whom the indication of the incident should be communicated and communicates the indication of the incident to identified stakeholders. In some examples, the stakeholders include PSAPS. In some examples, the indication of the incident is communicated to stakeholders that are particularly associated with the particular geographic region.

### II. Example Environment

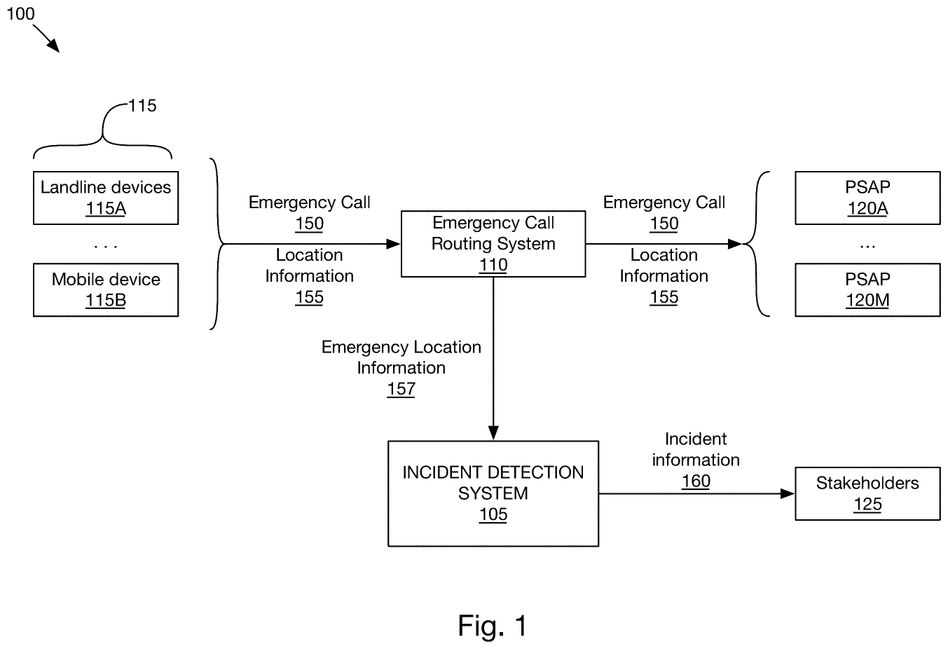

FIG. 1 illustrates an example of an environment 100 that includes various systems/devices that facilitate the detection of an incident based on network traffic generated by various networked devices. Example systems/devices of the environment 100 include an incident detection system 105, an emergency call routing system 110, one or more user communication devices 115, and a group of public safety access points 120.

Some examples of the user communication devices 115 correspond to devices that have relatively static/predefined locations. For instance, some examples of the user communication devices 115 correspond to landline devices 115 that communicate via POTS (plain old telephone service). Some examples of the landline devices 115 correspond to devices coupled to a local computer network such as the local computer network of a business, school, etc. In this regard, some examples of the landline devices 115 correspond to devices that facilitate voice-over-IP, such as computers that execute conferencing applications such as Skype®. Some examples of these applications may facilitate placing local and long-distance telephone calls from a computer. These applications may be assigned a particular phone number to facilitate receiving calls. In some examples, the geographic location (e.g., street address) associated with these landline devices may be determined by the emergency call routing system 110 using techniques that involve referencing an Automatic Number Identification (ANI) system and/or an Automatic Location Identification (ALI) database.

Some examples of the user communication devices 115 correspond to devices that have non-static locations. For instance, some examples of the user communication devices 115 correspond to mobile devices 115B. Some examples of the mobile devices 115B correspond to cellular telephones, tablets, etc. Some examples of the mobile device 115B communicate via a cellular telephone network, such as GSM, LTE, 5G, etc., cellular networks. Some examples of the cellular network are configured to use techniques that involve triangulation to determine the location of the mobile devices 115B. Some examples of the mobile device 115B comprise location circuitry that facilitates determining the geographic location of the mobile device 115B. Some examples of the location circuitry periodically (e.g., every second) determine location information associated with the mobile device 115B (e.g., the latitude and longitude of the mobile device 115B). In some examples, when an emergency call 150 (e.g., a 911 call) is made from the mobile device 115B, the cellular network communicates the emergency call 150 to the emergency call routing system 110 along with location information 155 that specifies an approximate geographic location of the mobile device 115B. Some examples of the emergency call 150 comprise voice information (e.g., a digitized representation of the user's voice). Some examples of the emergency location information 157 comprises geographic coordinates (e.g., x, y, z; latitude, longitude, etc.).

Some examples of the emergency call routing system 110 correspond to a 911 network. In this regard, some examples of the emergency call routing system 110 are configured to receive emergency calls 150 from various devices, such as landline devices 115A and mobile devices 115B of the environment 100 and to route the emergency calls 150 to the most appropriate Public Safety Answering Point (PSAP) 120. For example, some examples of the emergency call routing system 110 route the digitized representation of the user's voice to an appropriate PSAP 120.

Some examples of the emergency call routing system 110 route location information 155 associated with the emergency calls 150 to corresponding PSAPs 120. In this regard, some examples of the emergency call routing system 110 may include or be in communication with an Automatic Number Identification (ANI) system and/or an Automatic Location Identification (ALI) database to facilitate determining the street address associated with a landline phone. Some examples of the emergency call routing system receive location information 155 from various cellular systems to facilitate locating mobile devices 115B. Some examples of the emergency call routing system 110 maintain one or more databases that relate street addresses and/or regions to appropriate PSAPs 120 (e.g., PSAPs that are nearest the addresses and/or regions).

Some examples of the emergency call routing system 110 communicate emergency location information 157 to the incident detection system 105. Some examples of the emergency location information 157 correspond to records of network logs generated by the emergency call routing system 110. In some examples, the records are added to the network logs in real-time (e.g., as emergency calls 150 are being made). In some examples, the network logs are communicated to the incident detection system 105 over a network such as the Internet. In some examples, the network logs are communicated each time a new record is added to the network logs. In some examples, the network logs are communicated periodically, such as every five minutes. Some examples of the network logs conform to a specification, such as the NENA-STA-010.3d-2021 standard promulgated by the National Emergency Number Association (NENA) 911 Core Services Committee, i3 Architecture Working Group. In some examples, each record specifies an ANI associated with the user communication device 115, a location (e.g., street address, geographic coordinates, etc.) associated with the user communication device 115, the type of user communication device 150 (e.g., landline, mobile, computer application, etc.), and a timestamp that specifies the time at which the emergency call 150 was made. Other information may be included in each record.

Some examples of the PSAPs 120 correspond call centers that are responsible for receiving and handling emergency calls 150 from the public. The PSAPs 120 are generally staffed by trained operators skilled in gathering crucial information from callers and dispatching the appropriate emergency response resources. The operators at a PSAP 120 assess the nature and urgency of the emergency, gather essential details from the caller, and coordinate the response by relaying the information to the appropriate emergency services such as police, fire departments, or medical personnel.

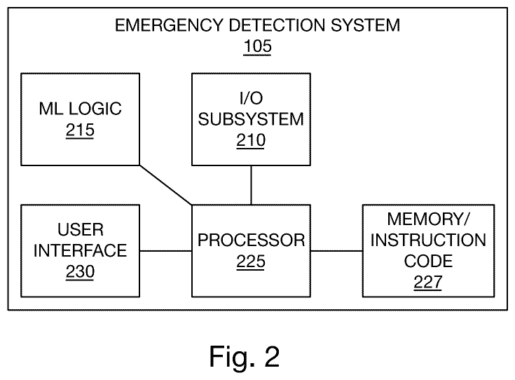

FIG. 2 illustrates an example of an incident detection system 105. Referring to the figure, the incident detection system 105 includes a memory 227, a processor 225, a user interface 230, an input/output (I/O) subsystem 210, and ML logic 215.

The processor 225 is in communication with the memory 227 and is configured to execute instruction code stored in the memory 227. The instruction code facilitates performing, by the incident detection system 105, various operations that are described herein. In this regard, some examples of the instruction code cause the processor 225 to control and coordinate various activities performed by the different subsystems of the incident detection system 105. Some examples of the processor 225 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the I/O subsystem 210 include one or more input/output interfaces configured to facilitate communications with entities outside of the incident detection system 105. Some examples of the I/O subsystem 210 include wireless communication circuitry configured to facilitate communicating information to and from the incident detection system 105. Examples of the wireless communication circuitry include cellular telephone communication circuitry configured to communicate information over a cellular telephone network such as a 3G, 4G, and/or 5G network. Other examples of the wireless communication circuitry facilitate the communication of information via a WiFi-based network, Bluetooth®, Zigbee®, near-field communication technology or a different wireless network.

Some examples of the I/O subsystem 210 are configured to communicate information via a RESTful API or a Web Service API. Some examples of I/O subsystem 210 implement a web browser to facilitate generating one or more web-based interfaces through which users of the incident detection system 105 and/or other systems interact with the incident detection system 105.

Some examples of the ML logic 215 are configured to, alone or in combination with other subsystems of the incident detection system 105, infer from features associated with the emergency calls 150 whether an incident has occurred at one or more particular geographic regions. Some examples of the ML logic 215 are configured to infer whether catastrophic incidents such as mass causality events (e.g., shooting, fire, etc.) have occurred rather than minor incidents (e.g., a medical emergency associated with an individual, car accident, etc.). In this regard, some examples of the ML logic 215 include hardware, software, or a combination thereof that is specifically configured to implement or assist in the implementation of various supervised and unsupervised machine learning models. Within examples, these can involve the implementation of a Holt-Winters algorithm, an exponential time smoothing (ETS) algorithm, an artificial neural network (ANN), a recurrent neural network (RNN), convolutional neural network (CNN), a seasonal autoregressive moving average (SARIMA) algorithm, a network of long short-term memories (LSTM), a gated recurring unit (GRU) algorithm. Examples of the ML logic 215 can implement other machine learning (ML) logic and/or AI algorithms.

As described in further detail below, some examples of the ML logic 215 are trained to infer whether an incident has occurred at one or more particular geographic regions based on training data based on the emergency location information 157 communicated from the emergency call routing system 110. Examples of the training data comprise records associated with emergency calls 150 made by user communication devices and, for each emergency call 150, an indication of whether the emergency call 150 was associated with (e.g., made in response to) a particular catastrophic incident. Examples of the record specify an ANI associated with the user communication device 115, a location (e.g., street address, geographic coordinates, etc.) associated with the user communication device 115, the type of user communication device 115 (e.g., landline, mobile, computer application, etc.), a timestamp that specifies the time at which the emergency call 150 was made, etc.

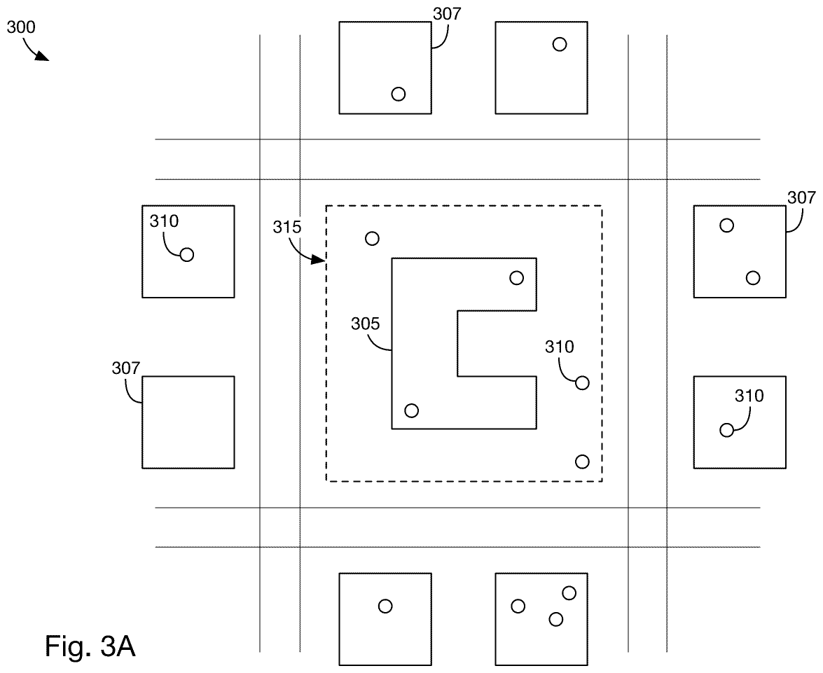

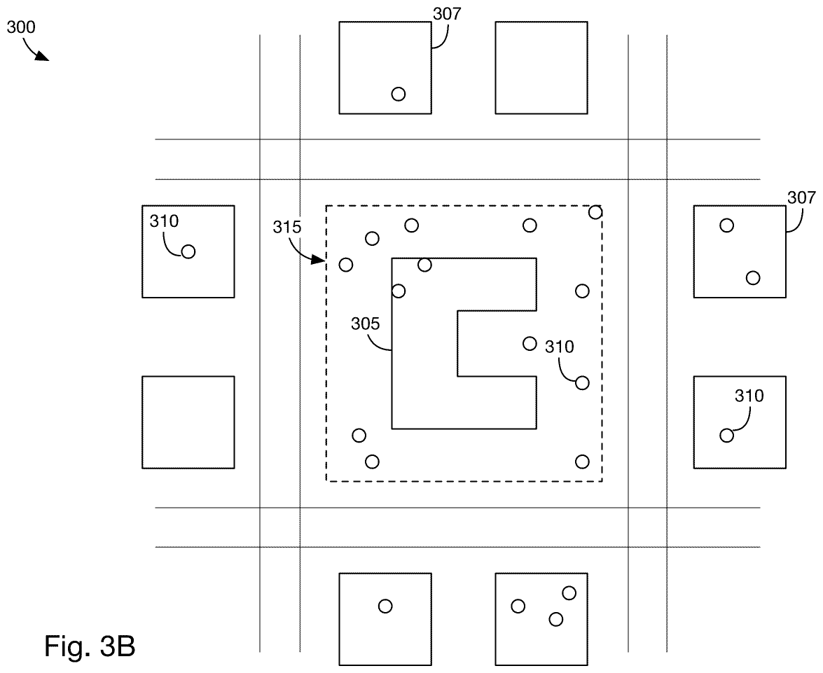

FIGS. 3A and 3B illustrate an example geographic area 300 in which emergency calls 150 may have been made. Shown in the figures are a primary structure 305 (e.g., a school building), other structures 307 (e.g., apartments, office buildings, etc.) near the primary structure 305, and emergency call locations 310 within the geographic region 300 at which emergency calls 150 were made during a particular period (e.g., over the course of a few hours). FIG. 3A illustrates example locations of emergency calls 150 that may have been made on a typical day. FIG. 3B illustrates example locations of emergency calls 150 that may have been made on a day on which a mass casualty event may have occurred.

As previously described, emergency location information 157, which specifies the locations of user communication devices 115 from which emergency calls 150 are made, is communicated to the incident detection system 105 from the emergency call routing system 110. For example, the locations of landline devices 115A may have been determined via an Automatic Number Identification (ANI) system and Automatic Location Identification (ALI) database of or in communication with the emergency call routing system 110. The locations of mobile devices 115B may have been determined via techniques that involve triangulating the location of the mobile device 115B using several cell towers. The emergency location information 157 is input to the ML logic 215, and the ML logic 215 infers based on the features of the emergency calls 150 (e.g., the locations of the user communication devices 115 from which the emergency calls 150 and the time or period over which the emergency calls 150 are made) whether a catastrophic incident (e.g., a mass casualty event) has occurred. For example, in FIG. 3A, the emergency call locations 310 are somewhat randomly distributed within the geographic region 300. In this situation, the ML logic 215 may infer from the emergency call locations 310, and the timing of the emergency calls 150 that a catastrophic incident has not occurred within the target region 315. On the other hand, in FIG. 3B, a significant number of emergency call locations 310 are clustered within the target region 315. In this situation, the ML logic 215 may infer from the emergency call locations 310 and timing of the emergency calls 150 that a catastrophic incident has occurred within the target region 315.

### III. Example Operations

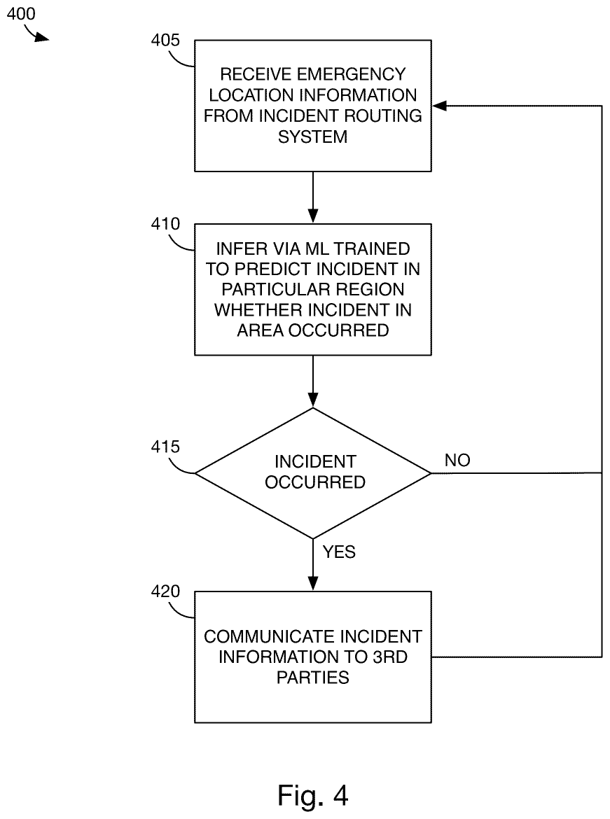

FIG. 4 illustrates examples of operations 400 that facilitate inferring the occurrence of a catastrophic incident at one or more particular geographic regions. These operations are performed by some examples of the systems described above (e.g., the incident detection system 105, the emergency call routing system 110, etc.). In some examples, one or more of these operations are implemented via instruction code, stored in corresponding data storage (e.g., memory 227) of these systems. Execution of the instruction code by corresponding processors of the systems causes these systems to perform these operations alone or in combination with other systems and/or devices.

The operations at block 405 involve the incident detection system 105 receiving emergency location information 157 from the emergency call routing system 110, and that is associated with emergency calls 150 made from user communication devices 115 such as landline devices 115A, mobile devices 115B, etc. Some examples of the emergency location information 157 correspond to records of network logs generated by the emergency call routing system 110. In some examples, the records are added to the network logs in real-time (e.g., as emergency calls 150 are being made). In some examples, the network logs are communicated to the incident detection system 105 over a network such as the Internet. Some examples of the network logs conform to a specification, such as the NENA-STA-010.3d-2021 standard promulgated by the National Emergency Number Association (NENA) 911 Core Services Committee, i3 Architecture Working Group. In some examples, each record specifies an ANI associated with the user communication device, a location (e.g., street address, geographic coordinates, etc.) associated with the user communication device 115, the type of user communication device 115 (e.g., landline, mobile, computer application, etc.), and timestamp that specifies the time at which the emergency call 150 was made. Other information may be included in each record.

The operations at block 410 involve the ML logic 215 inferring from features associated with the emergency calls 150 and that are specified within the emergency location information 157 whether an incident has occurred at one or more particular geographic regions 315. Some examples of the ML logic 215 infer whether there was a catastrophic incident such as a mass causality event (e.g., shooting, fire, etc.) within one or more predefined regions 315, such as a region 315 that covers a particular structure 305 (e.g., school and its playgrounds, parking lots, etc.)

In some examples, the emergency location information 157 input into the ML logic 215 is filtered so that only those records associated with emergency calls 150 made within a target region 315 are considered. For instance, the target region 315 may correspond to the target region 315 shown in FIGS. 3A and 3B. In this case, emergency calls 150 outside of the target region 315 will be ignored.

Some examples of the ML logic 215 are trained with training data that comprises records associated with emergency calls 150 made by user communication devices 115 and for each emergency call, an indication of whether the emergency call was associated with (e.g., made in response to) a particular catastrophic incident.

If at block 415, an incident (e.g., a catastrophic incident) has been inferred to have occurred, then the operations at block 420 are performed. The operations at block 420 involve the incident detection system 105 communicating incident information 160 to one or more remote systems or remote devices (e.g., mobile devices, personal computers, etc.) that are associated with one or more entities/stakeholders 125. In this regard, some examples of the incident detection system 105 comprise a database with records that relate stakeholders 125 (e.g., individuals, entities, etc.) to target regions 315. The records may specify stakeholder contact information (e.g., phone numbers, email addresses, etc.) through which the incident detection system 105 should contact corresponding stakeholders 125. Some examples of the user interface 230 of the incident detection system 105 are configured to generate a webpage that facilitates associating stakeholder information (e.g., name, contact information, etc.) with particular target regions 315. For instance, stakeholders associated with a particular school may include the school's administrators (e.g., principal, superintendent, resource officer). In this regard, one or more stakeholders may be associated with different target regions. For example, the resource officer for a large school district that includes, for example, fifty different schools may be associated with all fifty schools in the database so that when an incident is determined to have occurred at any of the schools, the resource officer is notified.

As an illustrative example, an administrator of a school may, via the webpage, generate an association between himself and a particular target region 315 that covers school A. The administrator may specify a phone number through which he may receive an SMS message. After the incident detection system 105 infers the occurrence of a catastrophic incident within the target region 315, the incident detection system 105 may communicate the incident information 160 via an SMS message to the phone number registered by the administrator. In some examples, the incident information 160 corresponds to a text message, and the text message may specify information such as a description of the target region 315 and the time at which the incident was determined to have occurred. Continuing with the example, the incident information 160 may specify the text “Catastrophic incident occurred near school A, today at 1:00 PM”.

In some examples, multiple stakeholders 125 may be associated with a particular target region 315 and in some instances the stakeholders 125 are notified of the occurrence of an incident according to a rank (e.g., the highest rank stakeholder 125 is notified first, followed by the next highest rank stakeholder 110). In this regard, some examples of the incident detection system 105 are configured to wait for approval from a particular stakeholder 125 (e.g., the highest rank stakeholder 125) before notifying lower-ranked stakeholders 125. As an illustrative example, the highest rank stakeholder 125 associated with a particular target region 315 may correspond to the chief of police of the corresponding city. The police chief may receive the incident information 160 (e.g., via SMS) and, in response, may communicate an indication to the incident detection system 105 (e.g., via SMS) that lower-ranked stakeholders 125 should not be notified or that they should not be notified until a predetermined period later. In some examples, the incident detection system 105 may wait for a period (e.g., 10 minutes) to receive the response from the police chief, and if the response is not received before the period expires, it may automatically notify the next highest-ranked stakeholder 125.

While the examples above describe determining the occurrence of a catastrophic incident based on emergency location information 157 communicated from an emergency call routing system 110, other indications of an emergency may be received by the incident detection system 105 from other sources and used alone or in combination with the emergency location information 157 to make this determination.

For instance, a panic system within a particular structure 305 may be in networked communication with the incident detection system 105 (e.g., via a computer network, landline network, cellular line, etc.). The panic system may have a unique ID, and that ID may be associated with a particular structure 305 or target region 315 such that when the panic system is activated, an indication of the activation is communicated to the incident detection system 105.

One or more gunshot spotter systems may be in networked communication with the incident detection system 105 (e.g., via a computer network, landline network, cellular line, etc.). The gunshot spotter systems may be configured to detect/sense the firing of a gun. Each gunshot spotter system may have a unique ID, and that ID may be associated with a particular structure or target region 315 such that when a gun is fired, an indication of the gunshot is communicated to the incident detection system 105.

In some examples, the incident detection system 105 is in networked communication with one or more social media servers and the incident detection system 105 monitors social media posts to determine whether incidents may have occurred at particular target regions 315. For example, the target region 315 may correspond to a particular school. In this regard, in some examples, the incident detection system 105 implements natural language processing (NLP) to search for social media posts that may refer to the name of the school. In some examples, when an unusually large number of posts that refer to the school are made during a relatively short period (e.g., less than 30 minutes), the incident detection system 105 infers that an incident may have occurred and alerts the appropriate stakeholders.

In some examples, the incident detection system 105 does not start monitoring the social media posts until after first inferring an incident to have occurred based on the emergency calls 150. In some examples, after inferring the occurrence of the incident based on the emergency calls 150, the incident detection system 105 reports the occurrence of the incident to appropriate stakeholders. After a predetermined waiting period (e.g., within 30 seconds of making the determination), the incident detection system 105 starts monitoring the social media servers for related posts. In some examples, the incident detection system 105 monitors the social media server for a predetermined period (e.g., 1 hour). If, within that time, one or more social media posts that refer to or are related to the target region 315 are made, the incident detection system 105 communicates a follow-up message to one or more stakeholders with one or more links to the social media posts so that the stakeholders may view the posts and perhaps take appropriate action.

In general, the inference made by the ML logic 215 that an incident has occurred corresponds to a statistical determination. For instance, the ML logic 215 may determine, based on the emergency location information 157, that there is a 51% probability of there being an incident at the target region 315. In some examples, the incident detection system 105 reports an indication of the incident when this probability exceeds a particular threshold (e.g., 60%).

In some examples, the incident detection system 105 indicates the probability in the message communicated to the stakeholder (e.g., “There is a 60% chance that an incident has occurred at school A”). In some examples, rather than (or in addition to) providing a numerical representation of the probability in the message, the incident detection system 105 represents the probability in layman's terms. In this regard, some examples of the incident detection system 105 comprise a lookup table or database that relates different probabilities or ranges of probabilities to various laymen's terms. The table below illustrates several examples of these mappings.

| Probability | Term |
|---|---|
| 50%-60% | “There may be some sort of incident |
| | happening at school XYZ.” |
| 61%-70% | “You should contact school XYZ. There may |
| | be an incident.” |
| 71%-80% | “Contact school XYZ immediately. It is very |
| | likely that there is an incident.” |
| 81%-100% | “There is definitely an incident at school |
| | XYZ. Take appropriate action.” |

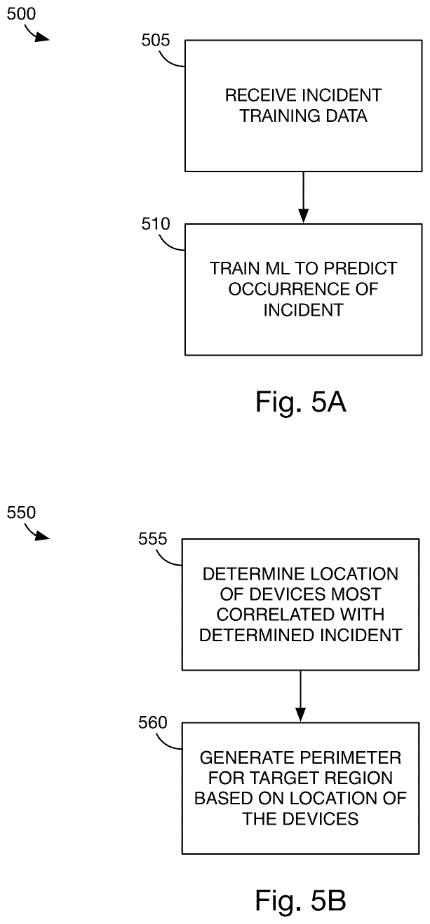

FIG. 5A illustrates examples of operations 500 that facilitate training the ML logic 215 to infer the occurrence of a catastrophic incident at one or more particular geographic regions. These operations are performed by some examples of the systems described above (e.g., the incident detection system 105). In some examples, one or more of these operations are implemented via instruction code, stored in corresponding data storage (e.g., memory 227) of these systems. Execution of the instruction code by corresponding processors of the systems causes these systems to perform these operations alone or in combination with other systems and/or devices.

The operations at block 505 involve the incident detection system 105 receiving training data. Examples of the training data comprise records associated with emergency calls 150 made by user communication devices 115 and, for each emergency call, an indication of whether the emergency call was associated with (e.g., made in response to) a particular catastrophic incident. Examples of the record specify an ANI associated with the user communication device, a location (e.g., street address, geographic coordinates, etc.) associated with the user communication device 115, the type of user communication device 115 (e.g., landline, mobile, computer application, etc.), a timestamp that specifies the time at which the emergency call was made, etc. Some examples of the records are specified in network logs communicated from the emergency call routing system 110. Some examples of the network logs conform to a specification, such as the NENA-STA-010.3d-2021 standard promulgated by the National Emergency Number Association (NENA) 911 Core Services Committee, i3 Architecture Working Group.

The operations at block 510 involve the incident detection system 105 training the ML logic 215 so that the ML logic 215 a) infers the occurrence of a catastrophic incident when receiving emergency calls 150 previously determined to be associated with (e.g., made in response to) a particular catastrophic incident, and b) does not infer the occurrence of a catastrophic incident when receiving different emergency calls 150. In this regard, in some examples, the ML logic 215 is trained by iteratively adjusting weights and biases of the ML logic 215 (e.g., via backpropagation and forward propagation techniques) until the output of the ML logic 215 makes the correct inferences regarding the training data. That is, the weights and biases of the ML logic 215 are adjusted so that when the training data indicates a catastrophic incident, the ML logic 215 infers the occurrence of the catastrophic incident and when the training indicates one or more emergencies but not necessarily an emergency associated with a catastrophic incident, or at least not a catastrophic incident at a particular target region 315, the ML logic 215 does not infer the occurrence of a catastrophic incident.

In some examples, the ML logic 215 is trained with training data associated with emergency incidents that occur at different times and/or at different target regions. For example, the training data may include emergency location information 157 associated with emergency calls 150 made over the span of ten years in a large metropolitan area. During that time, there may have been several catastrophic incidents in different target regions of the metropolitan area (e.g., school shootings at different high schools, shopping centers, etc.). As an example, suppose there are five target regions where such incidents have occurred. In this case, the ML logic 215 may have five outputs, one for each target region, that indicate the probability of the occurrence of a catastrophic incident at the target region.

FIG. 5B illustrates examples of operations 550 that facilitate determining a suitable perimeter for a target region 315. As noted above, in some examples, the emergency location information 157 input into the ML logic 215 is filtered so that only those records associated with emergency calls 150 made within a target region 315 are considered when determining whether a catastrophic incident has occurred.

The operations at block 555 involve the incident detection system 105 determining the location of those communication devices 115 (i.e., communication devices 115 through which emergency calls 150 were made) that are most correlated with a particular catastrophic incident. For instance, after training the ML logic 215, a sensitivity analysis may be performed on the training data to determine those emergency calls 150 specified in the training data that have the greatest influence on the inference made by the ML logic 215. For example, records may be removed from the training data, and the training data may be re-processed through the ML logic 215 to determine those emergency calls 150 that had the greatest influence on the inference result.

The operations at block 560 involve the incident detection system 105 generating a perimeter for the target region 315 based on the locations of those emergency calls 150 that had the greatest influence on the inference made by the ML logic 215. For example, suppose the emergency call locations 310 indicated in FIG. 3B were used to train the ML logic 215 and that the emergency call locations 310 clustered immediately around the structure 305 had the most influence on the inference made by the ML logic 215. In this case, the incident detection system 105 may determine the target region 315 as the smallest region that encompasses those emergency calls 150.

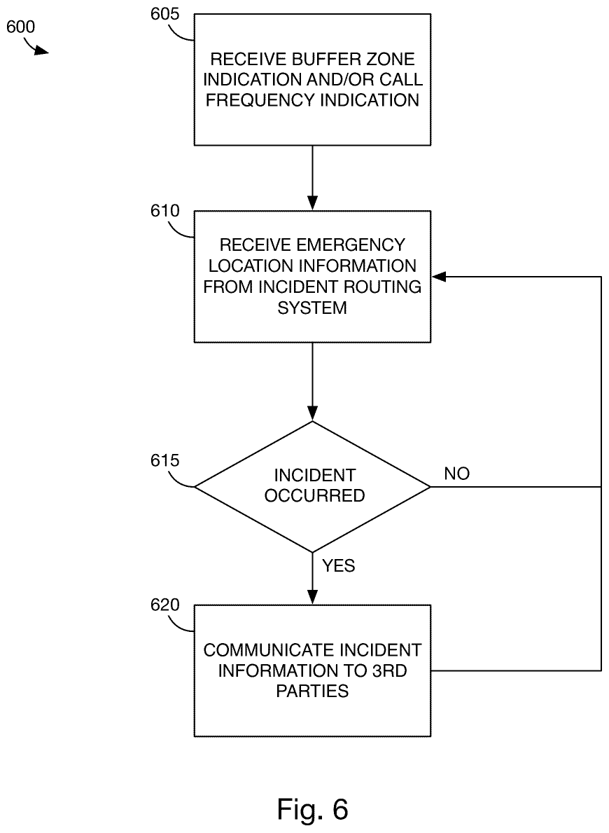

FIG. 6 illustrates examples of operations 600 that facilitate inferring or determining the occurrence of a catastrophic incident at one or more particular geographic regions. These operations are performed by some examples of the systems described above (e.g., the incident detection system 105, the emergency call routing system 110, etc.). In some examples, one or more of these operations are implemented via instruction code, stored in corresponding data storage (e.g., memory 227) of these systems. Execution of the instruction code by corresponding processors of the systems causes these systems to perform these operations alone or in combination with other systems and/or devices.

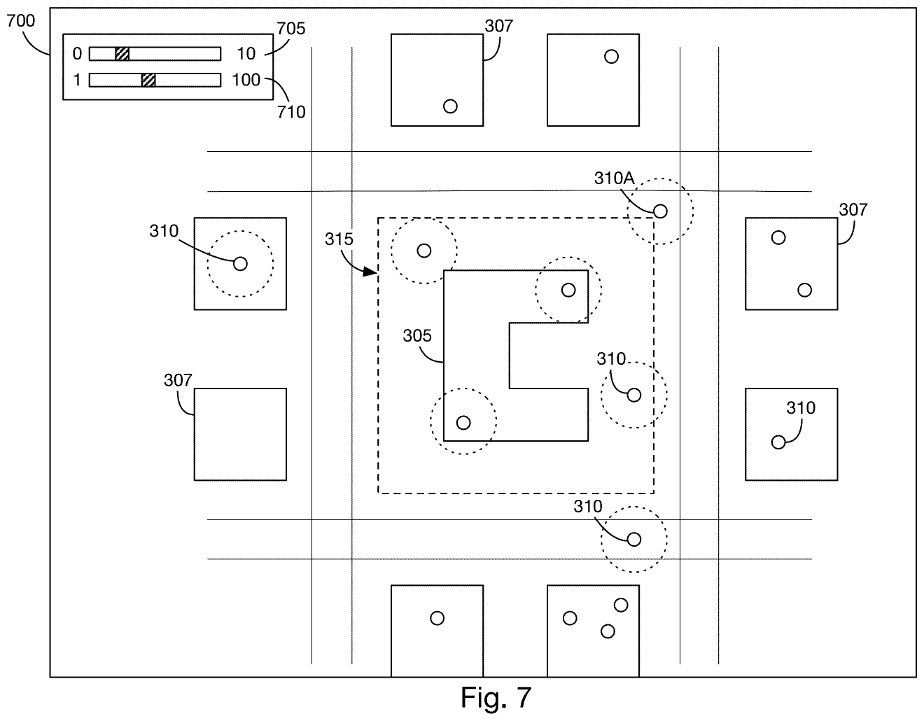

The operations are more clearly understood with reference to FIG. 7, which depicts an example of a user interface 700 generated by some examples of the incident detection system 105. The user interface 700 includes a buffer adjustment control 705 through which a buffer size indication is specified, and a call frequency control 710 through an emergency call frequency indication is specified. The details associated with these controls are discussed in further detail below.

The operations at block 605 involve the incident detection system 105 receiving a buffer zone indication and/or a call frequency indication. For example, a user may specify the buffer zone and the call frequency for a particular target region 315 via the user interface 700. In some examples, after specifying the buffer zone and the call frequency, the incident detection system 105 associates the specified buffer zone and the call frequency with the target region 315. In this regard, in some examples, different target regions 315 are associated with different buffer zones and/or call frequencies.

In some examples, the user interface 700 is updated in real-time by the incident detection system 105 to depict the locations associated with emergency calls specified in the emergency location information 157. In general, the location associated with any particular emergency call has a degree of uncertainty due to the limitations of the technology through which the location of the user communication device 115 is determined. For example, the true location of a particular user communication device 115 may be off by tens or hundreds of feet. In this regard, the buffer zone control 705 is used to specify this degree of uncertainty. For example, emergency call location 310A, which is associated with an emergency call made by a particular user communication device 115, specifies the location of the corresponding user communication device 115 to be just outside the upper right corner of the target region 315 as indicated by the solid circle. The circular dashed line that surrounds the solid circle/location defines a buffer region around this location within which the emergency call may have been made. That is, the true location of the user communication device 115 may be anywhere within the buffer zone. In some examples, the size of the buffer zone is specified by the user via adjustment of the buffer adjustment control 705. As discussed further below, in some examples, an emergency call is determined to have been made within the target region 315 when the buffer zone associated with the emergency call intersects the target region 315.

The operations at block 610 involve the incident detection system 105 receiving emergency location information 157 from the emergency call routing system 110, and that is associated with emergency calls 150 made from user communication devices 115 such as landline devices 115A, mobile devices 115B, etc. as described above in regard to FIG. 4.

The operations at block 615 involve determining whether an incident has occurred at one or more target regions 315. For instance, in some examples, the incident detection system 105 determines an incident to have occurred when the number of emergency calls determined to have been made within the target region 315 reaches or exceeds a threshold frequency (e.g., 10 emergency calls during a 1-minute period). In some examples, the user specifies the target call frequency via the call frequency control 710. As previously indicated, in some examples, the incident detection system 105 determines an emergency call to have been made within the target region 315 when the buffer zone associated with the emergency call intersects the target region 315.

If at block 615, an incident (e.g., a catastrophic incident) has been determined to have occurred, then the operations at block 620 are performed. The operations at block 620 involve the incident detection system 105 communicating incident information 160 to entities/stakeholders 125 as described above in regard to FIG. 4. If an incident has not been determined to have occurred, then the incident detection system 105 forgoes communication of incident information 160.

In some examples, the incident detection system 105 maintains a history of emergency calls, such as emergency calls made in a geographic area (e.g., a city) over a particular period (e.g., last five years). In some examples, the incident detection system 105 includes controls that allow a user to visualize these emergency calls. For instance, some examples of the user interface 700 include date range and playback controls that facilitate visualizing emergency calls made during the specified date range. In some examples, visualization of the emergency call history allows the user to determine appropriate settings for the buffer adjustment control 705 and the call frequency control 710. For instance, the user may be aware of certain times at which incidents have occurred at a particular target region. The user may use the playback controls to show emergency calls made around the times of the incidents and adjust the buffer adjustment control 705 and the call frequency control 710 so that the incident detection system 105 determines there to have been an incident or incidents at the correct times. After specifying the appropriate buffer adjustment and call frequency, the user may indicate to the incident detection system 105 that these settings should be associated with the target region 315 so that future incidents at the target region can be detected.

### IV. Example Computer Systems

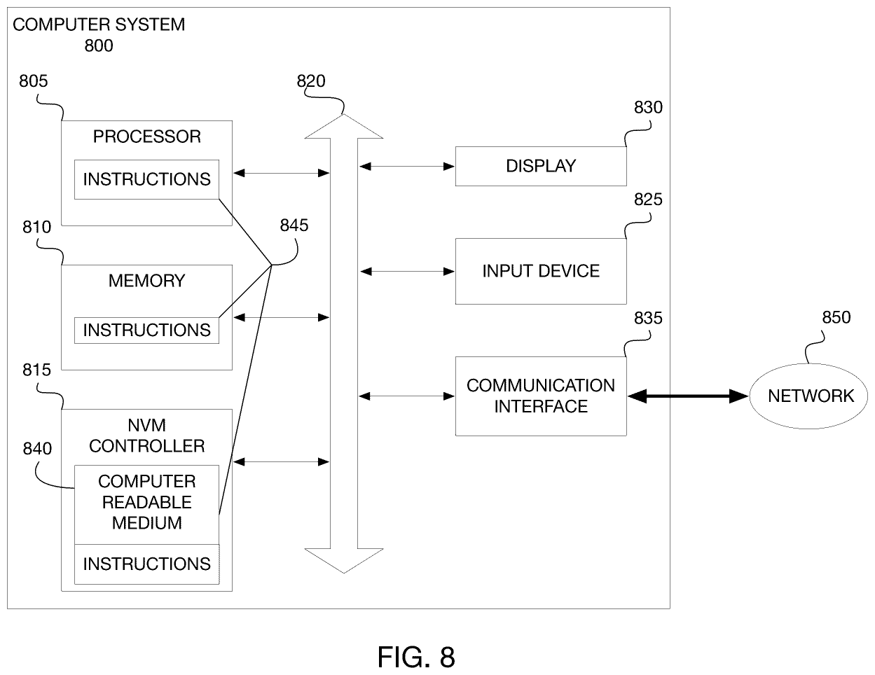

FIG. 8 illustrates an example of a computer system 800 that can form part of or implement any of the systems and/or devices described above. The computer system 800 can include a set of instructions 845 that the processor 805 can execute to cause the computer system 800 to perform any of the operations described above. An example of the computer system 800 can operate as a stand-alone device or can be connected, e.g., using a network, to other computer systems or peripheral devices.

In a networked example, the computer system 800 can operate in the capacity of a server or as a client computer in a server-client network environment, or as a peer computer system in a peer-to-peer (or distributed) environment. The computer system 800 can also be implemented or incorporated into various devices, such as a personal computer or a mobile device, capable of executing instructions 845 (sequential or otherwise), causing a device to perform one or more actions. Further, each of the systems described can include a collection of subsystems that individually or jointly execute a set, or multiple sets, of instructions to perform one or more computer operations.

The computer system 800 can include one or more memory devices 810 communicatively coupled to a bus 820 for communicating information. In addition, code operable to cause the computer system to perform operations described above can be stored in the memory 810. The memory 810 can be random-access memory, read-only memory, programmable memory, or any other type of memory or storage device.

The computer system 800 can include a display 830, such as a liquid crystal display (LCD), organic light-emitting diode (OLED) display, or any other display suitable for conveying information. The display 830 can act as an interface for the user to see processing results produced by processor 805.

Additionally, the computer system 800 can include an input device 825, such as a keyboard or mouse or touchscreen, configured to allow a user to interact with components of system 800.

The computer system 800 can also include a non-volatile memory (NVM) controller 815. The NVM controller 815 can include a computer-readable medium 840 (e.g., flash drive) in which the instructions 845 can be stored. The instructions 845 can reside completely, or at least partially, within the memory 810 and/or within the processor 805 during execution by the computer system 800. The memory 810 and the processor 805 also can include computer-readable media, as discussed above.

The computer system 800 can include a communication interface 835 to support communications via a network 850. The network 850 can include wired networks, wireless networks, or combinations thereof. The communication interface 835 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A computing system comprising:
one or more processors; and
one or more storage devices that comprise instruction code that is executable by the one or more processors to cause the computing system to:
receive, from an emergency call routing system, emergency location information associated with emergency calls placed by a plurality of user communication devices, wherein the emergency location information specifies geographic location information associated with locations of the user communication devices;
implement machine learning (ML) logic trained to infer based on the emergency location information whether an incident has occurred at one or more particular geographic regions;
communicate the emergency location information as input to the ML logic; and
after the ML logic indicates that an incident has occurred at the one or more particular geographic regions, communicate an indication of the incident to one or more third parties.

2. The computing system according to claim 1, wherein the instruction code that causes the computing system to communicate the emergency location information as input to the ML logic comprises instruction code that causes the computing system to:
filter the emergency location information according to a particular geographic area; and
communicate filtered emergency location information as input to the ML logic.

3. The computing system according to claim 1, wherein the instruction code that causes the computing system to communicate the indication of the incident to the one or more third parties comprises instruction code that causes the computing system to communicate the indication of the incident to one or more Public Safety Answering Points (PSAPs).

4. The computing system according to claim 3, wherein the instruction code that causes the computing system to communicate the indication of the incident to the one or more third parties comprises instruction code that causes the computing system to:
search a list for one or more entities to whom the indication of the incident is to be communicated; and
communicate the indication of the incident to identified one or more entities.

5. The computing system according to claim 4, wherein the instruction code causes the computing system to:
receive an indication of a particular geographic region and an indication of one or more entities to which the indication of the incident is to be communicated; and
associate the one or more entities with the particular geographic region.

6. The computing system according to claim 3, wherein the emergency location information is Internet Protocol (IP) based emergency location information that conforms to a NENA-STA-010.3d-2021 standard and wherein the emergency call routing system routes the emergency location information to one or more PSAPs.

7. The computing system according to claim 1, wherein the emergency location information associated with an emergency call from a particular user communication device comprises x, y, and z coordinates that specify a geographic location of the particular user communication device.

8. The computing system according to claim 1, wherein the instruction code causes the computing system to train the ML logic to infer based on the emergency location information whether an incident has occurred at one or more particular geographic regions based on training data, wherein the training data comprises emergency location information associated with emergency calls placed by a plurality of user communication devices and for each emergency call an indication of whether the emergency call was placed during an incident and at a location associated with the incident.

9. The computing system according to claim 1, further comprising:
a network interface,
wherein the instruction code causes the computing system to:
after the ML logic indicates that an incident has occurred at the one or more particular geographic regions, receive, from one or more social media servers, one or more posts;
determine whether one or more of the posts refer to one or more of the particular geographic regions; and
when one or more posts refer to one or more of the particular geographic regions, communicate a second indication of the incident to one or more third parties that includes one or more links to the one or more posts.

10. The computing system according to claim 9, wherein the instruction code that causes the computing system to receive the one or more posts comprises instruction code causes the computing system to:
wait a first predetermined period after the ML logic indicates that an incident has occurred before receiving the one or more posts; and
forgo receiving of the one or more posts a second predetermined period after the ML logic indicates that an incident has occurred.

11. A computing system comprising:
one or more processors; and
one or more storage devices that comprise instruction code that is executable by the one or more processors to cause the computing system to:
receive, from an emergency call routing system, emergency location information associated with emergency calls placed by a plurality of user communication devices, wherein the emergency location information specifies geographic location information associated with locations of the user communication devices;
determine whether a frequency of the emergency calls made during a predetermined period and within one or more particular geographic regions exceeds a threshold frequency;
when the frequency of the emergency calls exceeds the threshold frequency, communicate an indication of an incident to one or more third parties; and
when the frequency of the emergency calls does not exceed the threshold frequency, forgoing communication of the indication.

12. The computing system according to claim 11, wherein the instruction code that causes the computing system to:
communicate, to a remote system, a user interface that facilitates visualization of the locations of the user communication devices on the remote system;
receive, from the remote system, a buffer zone indication specified via the user interface that represents a degree of uncertainty of the locations of the user communication devices and a frequency indication specified via the user interface and that specifies the threshold frequency;
wherein determining whether the frequency of the emergency calls made during the predetermined period and within the one or more particular geographic regions exceeds the threshold frequency is determined based in part on the received buffer zone indication.

13. The computing system according to claim 11, wherein the instruction code that causes the computing system to communicate the indication of the incident to the one or more third parties comprises instruction code that causes the computing system to communicate the indication of the incident to one or more Public Safety Answering Points (PSAPs).

14. The computing system according to claim 13, wherein the instruction code that causes the computing system to communicate the indication of the incident to the one or more third parties comprises instruction code that causes the computing system to:
search a list for one or more entities to whom the indication of the incident is to be communicated; and
communicate the indication of the incident to identified one or more entities.

15. The computing system according to claim 14, wherein the instruction code causes the computing system to:
receive an indication of a particular geographic region and an indication of one or more entities to which the indication of the incident is to be communicated; and
associate the one or more entities with the particular geographic region.

16. The computing system according to claim 13, wherein the emergency location information is Internet Protocol (IP) based emergency location information that conforms to a NENA-STA-010.3d-2021 standard and wherein the emergency call routing system routes the emergency location information to one or more PSAPs.

17. The computing system according to claim 11, wherein the emergency location information associated with an emergency call from a particular user communication device comprises x, y, and z coordinates that specify a geographic location of the particular user communication device.

18. The computing system according to claim 11, further comprising a network interface, wherein the instruction code causes the computing system to:
after communicating the indication of the incident to one or more third parties, receive, from one or more social media servers, one or more social media posts;
determine whether one or more of the social media posts refer to one or more of the particular geographic regions; and
when one or more social media posts refer to one or more of the particular geographic regions, communicate a second indication of the incident to one or more third parties that includes one or more links to the one or more social media posts.

19. The computing system according to claim 18, wherein the instruction code that causes the computing system to receive the one or more social media posts comprises instruction code causes the computing system to:
wait a first predetermined period after communicating the indication to one or more third parties before receiving the one or more social media posts; and
forgo receiving of the one or more social media posts a second predetermined period after communicating the indication to one or more third parties before receiving the one or more social media posts.
